(19) United States
(12) Patent Application Publication
(10) Pub. No.: US 2025/0266965 A1
(43) Pub. Date: Aug. 21, 2025

(54) DEMODULATION REFERENCE SIGNAL PORTS FOR CO-SCHEDULED DEVICE

(71) Applicant: Nokia Technologies Oy, Espoo (FI)

(72) Inventors: Amol DHERE, Gistrup (DK); Karsten PETERSEN, Aalborg (DK); Axel MUELLER, Massy (FR); Stig BLÜCHER BRINK, Aalborg (DK)

(21) Appl. No.: 19/055,671

(22) Filed: Feb. 18, 2025

(30) Foreign Application Priority Data
Feb. 19, 2024 (GB) GB 2402312.9

(51) Int. Cl. H04L 5/00; H04W 72/23

(52) U.S. Cl. CPC H04L 5/0053; H04W 72/23

(57) ABSTRACT

Example embodiments of the present disclosure relate to methods, devices, apparatuses and computer readable storage medium of demodulation reference signal (DMRS) for co-scheduled device. In a method, a first apparatus receives, from a second apparatus, an indication of a time period within which at least one co-scheduled terminal device of the first apparatus is present and a set of DMRS ports allocated for the first apparatus and the at least one co-scheduled terminal device are constant. The first apparatus decodes one or more downlink data transmission in consecutive downlink slots within the time period at least based on the indication.

### CROSS-REFERENCE TO RELATED APPLICATION

This application claims priority to, and the benefit of, GB Application No. 2402312.9, filed Feb. 19, 2024, the contents of which are hereby incorporated by reference in their entirety.

### FIELDS

Various example embodiments of the present disclosure generally relate to the field of telecommunication and in particular, to methods, devices, apparatuses and computer readable storage medium for demodulation reference signal (DMRS) ports for co-scheduled device.

### BACKGROUND

In an ongoing third-generation partnership project (3GPP) radio access network 4 (RAN4) work item, advanced receivers for downlink (DL) multi user multiple-input-multiple-output (MU-MIMO) are being studied. The advanced receivers for DL MU-MIMO will use reduced complexity Maximum Likelihood (R-ML) receivers like sphere detector, QR decomposition based M-algorithm (QRD-M), QR decomposition based Maximum Likelihood Detector (QRML-D), or linear receivers like the enhanced interference rejection combining (E-IRC) receiver for cancellation of interference from co-scheduled user equipments (UEs) MIMO layers. Co-scheduled UEs are allocated overlapping time domain resource allocation (TDRA) and frequency domain resource allocation (FDRA) resources in the same slot as the target UE.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, an indication of a time period within which at least one co-scheduled terminal device of the first apparatus is present and a set of demodulation reference signal, DMRS, ports allocated for the first apparatus and the at least one co-scheduled terminal device are constant; and decode one or more downlink data transmission in consecutive downlink slots within the time period at least based on the indication.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, an indication of a time period within which at least one co-scheduled terminal device of the first apparatus is present and a set of demodulation reference signal, DMRS, ports allocated for the first apparatus and the at least one co-scheduled terminal device are constant.

In a third aspect of the present disclosure, there is provided a method. The method comprises: receiving, at a first apparatus from a second apparatus, an indication of a time period within which at least one co-scheduled terminal device of the first apparatus is present and a set of demodulation reference signal, DMRS, ports allocated for the first apparatus and the at least one co-scheduled terminal device are constant; and decoding one or more downlink data transmission in consecutive downlink slots within the time period at least based on the indication.

In a fourth aspect of the present disclosure, there is provided a method. The method comprises: transmitting, at a second apparatus to a first apparatus, an indication of a time period within which at least one co-scheduled terminal device of the first apparatus is present and a set of demodulation reference signal, DMRS, ports allocated for the first apparatus and the at least one co-scheduled terminal device are constant.

In a fifth aspect of the present disclosure, there is provided a first apparatus. The first apparatus comprises means for receiving, from a second apparatus, an indication of a time period within which at least one co-scheduled terminal device of the first apparatus is present and a set of demodulation reference signal, DMRS, ports allocated for the first apparatus and the at least one co-scheduled terminal device are constant; and means for decoding one or more downlink data transmission in consecutive downlink slots within the time period at least based on the indication.

In a sixth aspect of the present disclosure, there is provided a second apparatus. The second apparatus comprises means for transmitting, to a first apparatus, an indication of a time period within which at least one co-scheduled terminal device of the first apparatus is present and a set of demodulation reference signal, DMRS, ports allocated for the first apparatus and the at least one co-scheduled terminal device are constant.

In a seventh aspect of the present disclosure, there is provided a computer readable medium. The computer readable medium comprises instructions stored thereon for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow of signaling for DMRS ports for co-scheduled device according to some example embodiments of the present disclosure;

FIG. 3 illustrates another signaling flow of signaling for DMRS ports for co-scheduled device according to some example embodiments of the present disclosure;

FIG. 4 illustrates another signaling flow of signaling for DMRS ports for co-scheduled device according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As briefly mentioned, advanced receivers for DL MU-MIMO are proposed. Co-scheduled UEs are allocated overlapping TDRA and FDRA resources in the same slot as the target UE. These advanced receivers need interference parameters to enable channel estimation and cancelation or suppression of interference. These parameters include the FDRA, TDRA, DMRS ports, physical resource block (PRB) bundling size, Modulation order of the co-scheduled, i.e., interfering, UEs.

In some mechanisms, the target UE may assume a lot of these parameters to be same as its own in a practical deployment, while some of these parameters need to be blindly detected (BD), and some will be provided using Network assistance (NWA) signaling. These parameters are also captured in Table 1 below, which may refer to a standard such as technical report (TR) 38.878.

TABLE 1

| | RAN4 Default assumption | Signalling if RAN4 |
|---|---|---|
| | (If N/A, how could be obtained by | default assumption |
| Information | the UE) | not valid |
| The DMRS port | N/A (Obtained by UE blind | N/A |
| information for | detection) | |
| the co-scheduled UE | | |
| PRB bundling size | For the target and any co-scheduled | Introduce dedicated |
| for the co-scheduled | UEs in different CDM groups | RRC signalling to |
| UE Frequency domain | and with the same DMRS | indicate whether the |
| resource allocation | sequence, the target UE assumes | default assumptions |
| for the co-UE within | the precoding and resource | valid or not |
| each PRG of the target | allocation of the co-scheduled | |
| UE | UE are the same in the PRG- | |
| | level grid configured to the | |
| | target UE when PRG = 2 or 4. | |
| DMRS power boosting | Same as target UE | Introduce dedicated |
| for the co-scheduled | | RRC signalling to |
| UE | | indicate whether the |
| | | default assumptions |
| | | valid or not |
| Time domain resource | Same as target UE | Introduce dedicated |
| allocation information | | RRC signalling to |
| of the co-scheduled UE | | indicate whether the |
| | | default assumptions |
| | | valid or not |
| Frequency domain | N/A (Obtained by UE blind | N/A |
| resource allocation | detection) | |
| for the co-UE across | | |
| different PRGs | | |
| of the target UE: | | |
| CSI-RS location | UE assumes the target PDSCH is | No RRC signalling |
| of co-scheduled | not overlapped with the CSI-RS | is needed |
| UE (Only required | of the co-scheduled UE | |
| for R-ML) | | |
| Modulation order | N/A | |
| of co-scheduled UE | Obtained by DCI based network | |
| | assistance information or UE | |
| | blind detection | |

As can be seen that the target UE needs to blindly detect DMRS ports and FDRA of the co-scheduled UE, while NWA signaling will be provided for the Modulation order (MO). For MO there is a limited number of bits allocated in the downlink control information (DCI) which can provide the exact MO only for the basic case of all PRG/PRB having interference have the same MO. The blind detection of DMRS ports, FDRA needs to be performed with granularity of as small as 2 or 4 PRBs. This is because of the highlighted default assumption from Table 1 which states that precoding and resource allocation of co-scheduled UE are the same in PRG level grid configured to the target UE when PRG is 2 or 4 PRB.

In some mechanisms, the latest status on the expected blind detection performance and the NWA when it comes to DMRS ports and FDRA detection is captured. Table 2 below shows status of NWA signaling and UE capability for DMRS ports detection.

TABLE 2
Potential finer UE capability definitions

UE Capability for maximum number of DMRS ports detected

There is no UE capability introduced for # of DMRS ports to detect.
The UE is expected to detect up to 4 ports. It's up to UE
implementation which ports are detected.
Discussion is limited to R15 DMRS configurations.
FFS on NWA to inform the UE on potential co-scheduled ports.

However, there is no NWA signaling of DMRS ports which is agreed but it is still open for discussion. In addition, UE capability for number of DMRS ports it can detect is not agreed but is still being discussed as an alternative to NWA signaling.

As seen from Table 2, a UE is expected to detect up to 4 ports with release (Rel) 15 DMRS configurations. With these configurations up to 8 ports using Type 1 DMRS and up to 12 ports with are possible. Furthermore, with Rel 18 DMRS configurations this number goes all the way up to 24 ports. The limitation of 4 ports for blind detection is because of the limited number of resources and time available to detect the DMRS ports. NWA signaling for DMRS ports of co-UEs is in general a problem because the dynamic nature of the DMRS ports in dynamic multi-user pairing/scheduling will require dynamic signaling using DCI or MAC-CE. Some mechanisms only minimize the number of bits needed for dynamic signaling by only providing the set id at run time.

Moreover, from Table 2, it can be seen that UE capability of number of ports a UE can detect will not be introduced. Such a UE capability has following problems.

Network scheduler will likely ignore it as it brings severe restrictions in terms of finding UEs with similar capability and then co-scheduling them with their current throughput requirements and channel conditions.

It will be risk that this will be a per component carrier, per band per band combination capability. That is, a large amount of capability information will be sent to network which it will either not use for scheduling or, more likely, the operators will not configure such signaling as it eats into expensive initial attach resources.

Lastly signaling of RBG size will only help when RBG size is greater than PRG size and when all co-scheduled UEs are using Type 0 FDRA allocation.

According to some example embodiments of the present disclosure, there is provided a solution for DMRS ports for co-scheduled devices. In the solution, a first apparatus (such as a terminal device or a target UE) receives, from a second apparatus (such as a network device), an indication of a time period within which at least one co-scheduled terminal device of the first apparatus is present and a set of DMRS ports allocated for the first apparatus and the at least one co-scheduled terminal device are constant. The first apparatus decodes one or more downlink data transmission in consecutive downlink slots within the time period at least based on the indication. In this way, during the time period indicated by the network to the target UE, the combined set of DMRS ports used for all the co-scheduled UEs and the target UE is kept constant. On top of this the network can optionally schedule the UE with different ports for each slot within a time period to inform it about the complete set of ports used within that period. In this way, it avoids need of UE capability about number of ports it can detect and the complexity at network side to handle it. In addition, it enables UE implementation where it can get information about the DMRS ports using blind detection as well as information about its own previously scheduled ports.

Example embodiments of the present disclosure will be described in detail below with reference to the accompanying drawings.

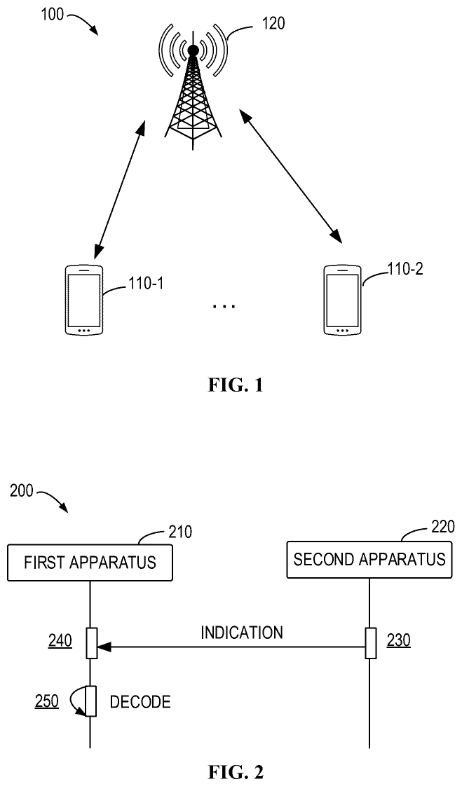

FIG. 1 illustrates an example communication environment 100 in which example embodiments of the present disclosure can be implemented. In the communication environment 100, a plurality of devices such as a terminal device 110-1, . . . and a terminal device 110-2 can communicate with a network device 120. As used herein, the terminal device 110-1 and the terminal device 110-2 can be individually referred to as a “terminal device 110”, or collectively referred to as “terminal devices 110”.

In some example embodiments, DL MU-MIMO is supported by the network device 120. For example, the terminal device 110-1 and the terminal device 110-2 are co-scheduled or paired. For the purpose of discussion, in the following description, the terminal device 110-1 may be referred to as a target terminal device, a paired UE, or a target UE, while the terminal device 110-2 may be referred to as a co-scheduled terminal device, a paired UE, or co-scheduled UE.

In some example embodiments, a link from the network device 120 to the terminal device 110 is referred to as a downlink (DL), and a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 2 illustrates a signaling flow of signaling for DMRS ports for co-scheduled device according to some example embodiments of the present disclosure. The signaling flow 200 involves a first apparatus 210 and a second apparatus 220.

In the following, for the purpose of discussion, some example embodiments will be described with the first apparatus 210 being implemented as the terminal device 110 in FIG. 1, and the second apparatus 220 being implemented as the network device 120 in FIG. 1. However, in some example embodiments, operations described in connection with a terminal device may be implemented at a network device or other device, and operations described in connection with a network device may be implemented at a terminal device or other device.

In operation, the second apparatus 220 transmits (230), to the first apparatus 210, an indication of a time period within which at least one co-scheduled terminal device of the first apparatus 210 is present and a set of DMRS ports allocated for the first apparatus 210 and the at least one co-scheduled terminal device are constant. The first apparatus 210 receives (240) the indication. For example, the time period (referred to as “T_{period}”) may be determined by the second apparatus 220 such as a network scheduler. During the time period, the set of DMRS ports allocated to the first apparatus 210 and its co-scheduled UEs are kept constant. By way of example, the indication may be transmitted (230)/received (240) via a radio resource control (RRC) message, a medium access control (MAC) control element (CE), DCI, or any other suitable message or signaling. Scope of the present disclosure is not limited here.

The first apparatus 210 decode (250) one or more downlink data transmission in consecutive downlink slots within the time period at least based on the indication.

In some example embodiments, the first apparatus 210 and the at least one co-scheduled terminal device may be co-scheduled over same and/or overlapping time and frequency resources.

In some example embodiments, the first apparatus 210 may receive, from the second apparatus 220, information of different DMRS ports of the set of DMRS ports in the consecutive downlink slots within the time period.

In some example embodiments, the first apparatus 210 may receive, from the second apparatus 220 along with the indication, information of a plurality of sets of DMRS ports for scheduling the first apparatus 210 and the at least one co-scheduled terminal device. At least one set of DMRS ports from the plurality of sets of DMRS ports are kept constant within the time period. A DMRS port is allowed to be associated with more than one set from the plurality of sets of DMRS ports. By way of example, the plurality of sets may include sets 1: {0,1,2,3}, set 2: {0,1,4,5}, set 3: {4,5,6,7}, and the like.

In some example embodiments, the first apparatus 210 may receive the indication and the information via at least one of: an RRC message, a MAC CE, DCI, or any other suitable message or signaling. The indication and the information may be transmitted (received) separately, or in combination.

In some example embodiments, the first apparatus 210 may receive, in a first downlink slot in the consecutive downlink slots within the time period, first information, indicating a first pre-determined number of DMRS ports from the set of DMRS ports. The first apparatus 210 may store the first pre-determined number of DMRS ports. The first apparatus 210 may perform a first blind detection on a second pre-determined number of DMRS ports randomly selected from the set of DMRS ports. For example, if the first pre-determined number of DMRS ports include Y={0, 1}, the second pre-determined number of DMRS ports may be referred to as X.

In some example embodiments, if a decoding of the first information based on a result of the first blind detection on the second pre-determined number of DMRS ports fails, the first apparatus 210 may store in-phase/quadrature (I/Q) data associated with the first downlink slot. Alternatively, or in addition, if the decoding of the first information based on a result of the first blind detection on the second pre-determined number of DMRS ports is successful, the first apparatus 210 may store detected DMRS ports from the second pre-determined number of DMRS ports.

In some example embodiments, the first apparatus 210 may receive, in a second downlink slot in the consecutive downlink slots within the time period, second information indicating a third pre-determined number of DMRS ports from the set of DMRS ports. For example, the third pre-determined number of DMRS ports include [5, 6]. The first apparatus 210 may perform a second blind detection on the first pre-determined number of DMRS ports and a fourth pre-determined number of DMRS ports. The fourth number equals to the second number minus the size of first pre-determined number of ports. The first apparatus 210 may decode the second information associated with the second downlink slot based on a result of the second blind detection.

In some example embodiments, the first apparatus 210 may perform a third blind detection on the stored I/Q data associated with the first downlink slot based on the third pre-determined number of DMRS ports and the fourth pre-determined number of DMRS ports. The first apparatus 210 may decode the first information associated with the first downlink slot based on a result of the third blind detection.

In some example embodiments, the first apparatus 210 may receive, in a first downlink slot in the consecutive downlink slots within the time period, first information, indicating a first pre-determined number of DMRS ports from the set of DMRS ports. The first apparatus 210 may store the first pre-determined number of DMRS ports. The first apparatus 210 may perform a first blind detection on a second pre-determined number of DMRS ports randomly selected from DMRS ports other than the first pre-determined number of DMRS ports in at least one set of DMRS ports associated with the first pre-determined number of DMRS ports from the plurality of sets of DMRS ports. For example, if the first pre-determined number of DMRS ports include Y={0, 1}, the second pre-determined number of DMRS ports may be referred to as X. In embodiments where the first pre-determined number of DMRS ports including ports {0, 1}, the second pre-determined number of DMRS ports may be selected from ports {2, 3, 4, 5}.

In some example embodiments, if a decoding of the first information based on a result of the first blind detection on the second pre-determined number of DMRS ports fails, the first apparatus 210 may store in-phase/quadrature (I/Q) data associated with the first downlink slot. Alternatively, or in addition, in some example embodiments, if the decoding of the first information based on a result of the first blind detection on the second pre-determined number of DMRS ports is successful, the first apparatus 210 may store detected DMRS ports from the second pre-determined number of DMRS ports.

In some example embodiments, the first apparatus 210 may receive, in a second downlink slot in the consecutive downlink slots within the time period, second information indicating a third pre-determined number of DMRS ports from a first set of DMRS ports in at least one set of DMRS ports associated with the first pre-determined number of DMRS ports. For example, the third pre-determined number of DMRS ports may include ports {4, 5}. The first apparatus 210 may perform a second blind detection on a fourth pre-determined number of DMRS ports selected from at least one of the set from the plurality of sets of DMRS ports which contains both first and third pre-determined DMRS ports. The first apparatus 210 may decode the second information associated with the second downlink slot based on a result of the second blind detection.

In some example embodiments, the first apparatus 210 may perform a third blind detection on the stored I/Q data associated with the first downlink slot based on the fourth pre-determined number of DMRS ports selected from at least one of the set from the plurality of sets of DMRS ports which contains both first and third pre-determined DMRS ports. The first apparatus 210 may decode the first information associated with the first downlink slot based on a result of the third blind detection.

In this way, during the time period indicated by the network to the target UE, the combined set of DMRS ports used for all the co-scheduled UEs and the target UE is kept constant. On top of this the network can optionally schedule the UE with different ports for each slot within a time period to inform it about the complete set of ports used within that period. In this way, it avoids need of UE capability about number of ports it can detect and the complexity at network side to handle it. In addition, it enables UE implementation where it can get information about the DMRS ports using blind detection as well as information about its own previously scheduled ports.

In this way, an efficient blind detection algorithm for co-scheduled UEs DMRS ports can be achieved. With such reliable and efficient solution, advanced receivers can be implemented.

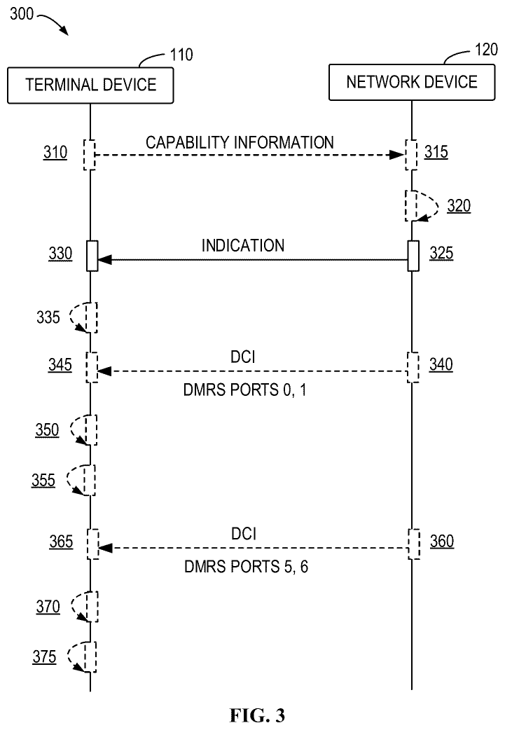

FIG. 3 illustrates another signaling flow 300 of signaling for DMRS ports for co-scheduled device according to some example embodiments of the present disclosure. The signaling flow 300 involves the terminal 110 and the network device 120 in FIG. 1. For purpose of illustration, the signaling flow 300 will be described with respect to FIG. 1.

In operation, the terminal device 110 may transmit (310) capability information to the network device 120. The network device 120 may receive (315) the capability information. The capability information may indicate capability of advanced receiver for MU-MIMO. For example, the capability information may be referred to as UE capability information.

In some example embodiments, the network device 120 may determine (320) a suitable time period T_{period} for keeping the set of DMRS ports allocated to the terminal device 110 and its co-scheduled UEs constant.

The network device 120 transmits (325) an indication of the time period to the terminal device 110. The terminal device 110 receives (330) the indication. For example, the indication may be transmitted via a RRC reconfiguration message, a MAC CE, DCI, or any other suitable signaling. In some example embodiments, the network device 120 such as a run time network scheduler may allocate different ports to the terminal device 110 in consecutive downlink slots during the particular period of length T_{period}. In some example embodiments, the terminal device 110 may store (335) the received period T_{period} for future use.

The network device 120 may transmit (340) information of different DMRS ports of the set of DMRS ports in the consecutive downlink slots within the time period to the terminal device 110. The terminal device 110 may receive (345) the information. For example, the network device 120 may transmit (340) information (via DCI or RRC or MAC CE) to the terminal device 110. The information may indicate for example DMRS ports 0, 1. In the following description, some example embodiments will be described with the information being transmitted via DCI.

In some example embodiments, if the first physical downlink shared channel (PDSCH) slot within a time period is received, the Y number of DMRS ports given in the DCI are stored for future use. The terminal device 110 may choose (350) X random ports for blind detection and attempts demodulation based on detection result. Value of X may be implementation dependent. For example, Y=2 ports may be scheduled {0,1}

In some example embodiments, in case of decoding failure, the terminal device 110 may store (355) the received I/Q data for the slot and in case of success the detected ports are stored for future use.

In some example embodiments, the network device 120 may transmit (360) the information of different DMRS ports of the set of DMRS ports in the consecutive downlink slots within the time period to the terminal device 110. The terminal device 110 may receive (365) the information. For example, the information may be via DCI. The information may indicate DMRS ports 5, 6.

In some example embodiments, if the next PDSCH slot within the same period is received (365), the terminal device 110 may perform (370) blind detection of ports by including the DMRS ports which were scheduled/detected for previous slot as well as X-Y randomly chosen ports. Demodulation and decoding of the slot based on detection results may be performed. For example, Blind detection of ports {0,1} and X−2 random ports is done.

In some example embodiments, the terminal device 110 may attempt to perform (375) a blind detection of previously failed slots stored I/Q data by including Y ports scheduled for current slot as well as X−Y randomly chosen ports. For example, blind detection of ports {5,6} and X−2 random ports may be done.

In this way, during the time period indicated by the network to the target UE, the combined set of DMRS ports used for all the co-scheduled UEs and the target UE is kept constant. On top of this the network can optionally schedule the UE with different ports for each slot within a time period to inform it about the complete set of ports used within that period. In this way, it avoids need of UE capability about number of ports it can detect and the complexity at network side to handle it. In addition, it enables UE implementation where it can get information about the DMRS ports using blind detection as well as information about its own previously scheduled ports.

In this way, an efficient blind detection algorithm for co-scheduled UEs DMRS ports can be achieved. With such reliable and efficient solution, advanced receivers can be implemented.

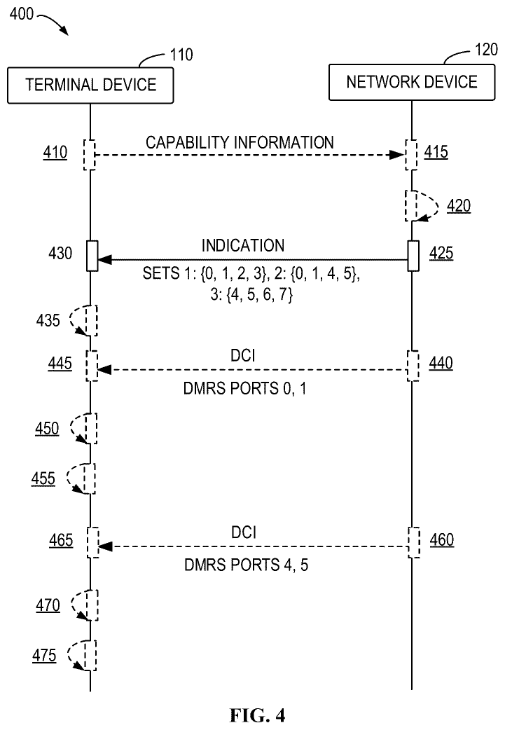

FIG. 4 illustrates another signaling flow 400 of signaling for DMRS ports for co-scheduled device according to some example embodiments of the present disclosure. The signaling flow 400 involves the terminal 110 and the network device 120 in FIG. 1. For purpose of illustration, the signaling flow 400 will be described with respect to FIG. 1.

In operation, the terminal device 110 may transmit (410) capability information to the network device 120. The network device 120 may receive (415) the capability information. The capability information may indicate capability of advanced receiver for MU-MIMO. For example, the capability information may be referred to as UE capability information.

In some example embodiments, the network device 120 may determine (420) a suitable time period T_{period} for keeping the set of DMRS ports allocated to the terminal device 110 and its co-scheduled UEs constant. In addition, the network device 120 may determine sets of DMRS ports for scheduling the terminal device 110 and its co-scheduled UEs. For example, the network device 120 may determine N=N_{target}+N_{intf} antenna port for the terminal device 110.

The network device 120 transmits (425) an indication of the time period and the sets of DMRS ports to the terminal device 110. The terminal device 110 receives (430) the indication. For example, the indication may be transmitted via a RRC reconfiguration message, a MAC CE, DCI, or any other suitable signaling. In this way, it eliminates the need for dynamic signaling of exact set identifier (ID).

In some example embodiments, the network device 120 such as a run time network scheduler may allocate different ports to the terminal device 110 from the chosen set, in consecutive downlink slots during a particular period of length T_{period}. In some example embodiments, the terminal device 110 may store (435) the received period T_{period} and the DMRS sets for future use.

The network device 120 may transmit (440) information of different DMRS ports of the set of DMRS ports in the consecutive downlink slots within the time period to the terminal device 110. The terminal device 110 may receive (445) the information. For example, the network device 120 may transmit (440) information (via DCI or RRC or MAC CE) to the terminal device 110. The information may indicate for example DMRS ports 0,1. In the following description, some example embodiments will be described with the information being transmitted via DCI.

In some example embodiments, when the first PDSCH slot within a time period is received, the Y number of DMRS ports given in the DCI scheduling it are stored for future use. The terminal device 110 may determine possible set ids containing the scheduled DMRS ports and choose (455) X random ports for blind detection from the remaining ports within those sets. For example, the scheduled Y=2, ports {0,1} are in set-id 1 and 2. So the terminal device 110 may choose X ports from {2,3,4,5}

In case of decoding failure, the terminal device 110 may store (455) the received I/Q data for the slot and in case of success the detected ports are stored for future use.

In some example embodiments, the network device 120 may transmit (460) the information of different DMRS ports of the set of DMRS ports in the consecutive downlink slots within the time period to the terminal device 110. The terminal device 110 may receive (465) the information. For example, the information may be via DCI. The information may indicate DMRS ports 5, 6.

In some example embodiments, when the next PDSCH slot within the same period is received, it narrows down the number of sets by only including the sets with DMRS ports allocated or detected in previous and current slots. Then, the terminal device 110 may perform (470) blind detection of up to X ports from the reduced number of sets followed by demodulation and decoding of the slot based on detection results. For example, the scheduled, Y=2, ports {4,5} in current slot and ports {0,1} in previous slot narrow down the possible sets to set-id 1. So, the terminal device 110 may choose up to X ports from {0,1} for blind detection.

The terminal device 110 may attempt to perform (475) blind detection of previously failed slots stored I/Q data by including ports scheduled for current slot as well as X−2 randomly chosen ports.

In this way, during the time period indicated by the network to the target UE, the set of DMRS ports used for all the co-scheduled UEs and the target UE is kept constant. In addition, the search space for DMRS port detection can be reduced. At the same time, the need for dynamic signaling using DCI is eliminated. Network can schedule multiple sets of DMRS ports for paired UEs using RRC and a periodicity during which the set being used is kept constant. Network can optionally schedule the UE with different ports for each slot within a time period to inform it about the exact set id being used within that period.

These embodiments can avoid dynamic signalling of set-ids using DCI or MAC-CE. Furthermore, it enables UE implementation where it can know the set-id which is being used over the entire time period and there by limit the search space of DMRS ports in that period.

It is to be understood that these described DMRS port number, port ID, port set are only for the purpose of illustration, without suggesting any limitation. Any suitable DMRS port may be applied. Scope of the present disclosure is not limited here.

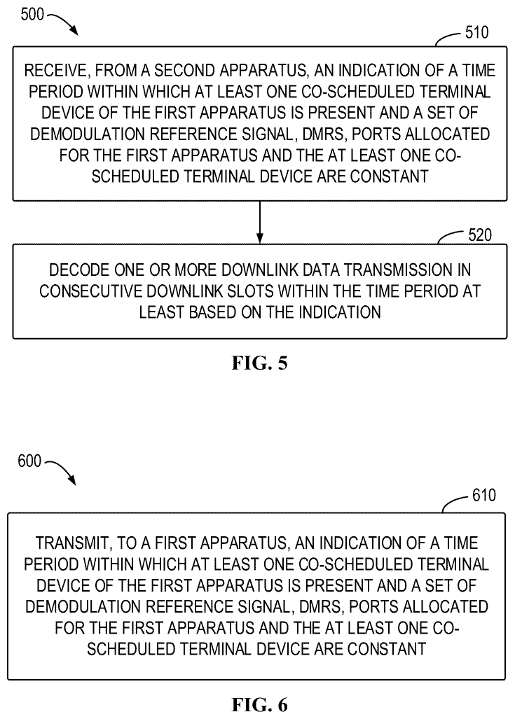

FIG. 5 shows a flowchart of an example method 500 implemented at a first apparatus in accordance with some example embodiments of the present disclosure. For the purpose of discussion, the method 500 will be described from the perspective of the first apparatus 210 in FIG. 2.

At block 510, the first apparatus 210 receives, from a second apparatus, an indication of a time period within which at least one co-scheduled terminal device of the first apparatus is present and a set of demodulation reference signal, DMRS, ports allocated for the first apparatus and the at least one co-scheduled terminal device are constant.

At block 520, the first apparatus 210 decodes one or more downlink data transmission in consecutive downlink slots within the time period at least based on the indication.

In some example embodiments, the first apparatus and the at least one co-scheduled terminal device are co-scheduled over same and/or overlapping time and frequency resources.

In some example embodiments, the method 500 further comprises: receiving the indication via at least one of the following: a radio resource control, RRC, message, a medium access control-control element, MAC-CE, or downlink control information, DCI.

In some example embodiments, the method 500 further comprises: receiving, from the second apparatus, information of different DMRS ports of the set of DMRS ports in the consecutive downlink slots within the time period.

In some example embodiments, the method 500 further comprises: receiving, from the second apparatus along with the indication, information of a plurality of sets of DMRS ports for scheduling the first apparatus and the at least one co-scheduled terminal device, wherein at least one set of DMRS ports from the plurality of sets of DMRS ports are kept constant within the time period, and wherein a DMRS port is allowed to be associated with more than one set from the plurality of sets of DMRS ports.

In some example embodiments, the method 500 further comprises: receiving the indication and the information via at least one of the following: a radio resource control, RRC, message, a medium access control-control element, MAC-CE, or downlink control information, DCI.

In some example embodiments, the method 500 further comprises: receiving, in a first downlink slot in the consecutive downlink slots within the time period, first information, indicating a first pre-determined number of DMRS ports from the set of DMRS ports; storing the first pre-determined number of DMRS ports; and performing a first blind detection on a second pre-determined number of DMRS ports randomly selected from the set of DMRS ports.

In some example embodiments, the method 500 further comprises: in accordance with a determination that a decoding of the first information based on a result of the first blind detection on the second pre-determined number of DMRS ports fails, storing in-phase/quadrature, I/Q, data associated with the first downlink slot; or in accordance with a determination that the decoding is successful, storing detected DMRS ports from the second pre-determined number of DMRS ports.

In some example embodiments, the method 500 further comprises: receiving, in a second downlink slot in the consecutive downlink slots within the time period, second information indicating a third pre-determined number of DMRS ports from the set of DMRS ports; performing a second blind detection on the first pre-determined number of DMRS ports and a fourth pre-determined number of DMRS ports, wherein the fourth number equals to the second number minus the size of first pre-determined number of ports; and decoding the second information associated with the second downlink slot based on a result of the second blind detection.

In some example embodiments, the method 500 further comprises: performing a third blind detection on the stored I/Q data associated with the first downlink slot based on the third pre-determined number of DMRS ports and the fourth pre-determined number of DMRS ports; and decoding the first information associated with the first downlink slot based on a result of the third blind detection.

In some example embodiments, the method 500 further comprises: receiving, in a first downlink slot in the consecutive downlink slots within the time period, first information, indicating a first pre-determined number of DMRS ports from the set of DMRS ports; storing the first pre-determined number of DMRS ports; and performing a first blind detection on a second pre-determined number of DMRS ports randomly selected from DMRS ports other than the first pre-determined number of DMRS ports in at least one set of DMRS ports associated with the first pre-determined number of DMRS ports from the plurality of sets of DMRS ports.

In some example embodiments, the method 500 further comprises: in accordance with a determination that a decoding of the first information based on a result of the first blind detection on the second pre-determined number of DMRS ports fails, storing in-phase/quadrature, I/Q, data associated with the first downlink slot; or in accordance with a determination that the decoding is successful, storing detected DMRS ports from the second pre-determined number of DMRS ports.

In some example embodiments, the method 500 further comprises: receiving, in a second downlink slot in the consecutive downlink slots within the time period, second information indicating a third pre-determined number of DMRS ports from a first set of DMRS ports in at least one set of DMRS ports associated with the first pre-determined number of DMRS ports; performing a second blind detection on a fourth pre-determined number of DMRS ports selected from at least one of the set from the plurality of sets of DMRS ports which contains both first and third pre-determined DMRS ports; and decoding the second information associated with the second downlink slot based on a result of the second blind detection.

In some example embodiments, the method 500 further comprises: performing a third blind detection on the stored I/Q data associated with the first downlink slot based on the fourth pre-determined number of DMRS ports selected from at least one of the set from the plurality of sets of DMRS ports which contains both first and third pre-determined DMRS ports; and decoding the first information associated with the first downlink slot based on a result of the third blind detection.

In some example embodiments, the first apparatus comprises a terminal device and the second apparatus comprises a network device.

FIG. 6 shows a flowchart of an example method 600 implemented at a second apparatus in accordance with some example embodiments of the present disclosure. For the purpose of discussion, the method 600 will be described from the perspective of the second apparatus 220 in FIG. 2.

At block 610, the second apparatus 220 transmits, to a first apparatus, an indication of a time period within which at least one co-scheduled terminal device of the first apparatus is present and a set of demodulation reference signal, DMRS, ports allocated for the first apparatus and the at least one co-scheduled terminal device are constant.

In some example embodiments, the first apparatus and the at least one co-scheduled terminal device are co-scheduled over same and/or overlapping time and frequency resources.

In some example embodiments, the method 600 further comprises: transmitting the indication via at least one of the following: a radio resource control, RRC, message, a medium access control-control element, MAC-CE, or downlink control information, DCI.

In some example embodiments, the method 600 further comprises: transmitting, to the first apparatus, information of different DMRS ports of the set of DMRS ports in consecutive downlink slots within the time period.

In some example embodiments, the method 600 further comprises: transmitting, to a first apparatus along with the indication, information of a plurality of sets of DMRS ports for scheduling the first apparatus and at least one co-scheduled terminal device of the first apparatus, wherein at least one set of DMRS ports from the plurality of sets of DMRS ports is kept constant within the time period, and wherein a DMRS port is allowed to be associated with more than one set from the plurality of sets of DMRS ports.

In some example embodiments, the method 600 further comprises: transmitting the indication and the information via at least one of the following: a radio resource control, RRC, message, a medium access control-control element, MAC-CE, or downlink control information, DCI.

In some example embodiments, the first apparatus comprises a terminal device and the second apparatus comprises a network device.

In some example embodiments, a first apparatus capable of performing any of the method 500 (for example, the first apparatus 210 in FIG. 2) may comprise means for performing the respective operations of the method 500. The means may be implemented in any suitable form. For example, the means may be implemented in a circuitry or software module. The first apparatus may be implemented as or included in the first apparatus 210 in FIG. 2.

In some example embodiments, the first apparatus comprises means for receiving, from a second apparatus, an indication of a time period within which at least one co-scheduled terminal device of the first apparatus is present and a set of demodulation reference signal, DMRS, ports allocated for the first apparatus and the at least one co-scheduled terminal device are constant; and means for decoding one or more downlink data transmission in consecutive downlink slots within the time period at least based on the indication.

In some example embodiments, the first apparatus and the at least one co-scheduled terminal device are co-scheduled over same and/or overlapping time and frequency resources.

In some example embodiments, the first apparatus further comprises: means for receiving the indication via at least one of the following: a radio resource control, RRC, message, a medium access control-control element, MAC-CE, or downlink control information, DCI.

In some example embodiments, the first apparatus further comprises: means for receiving, from the second apparatus, information of different DMRS ports of the set of DMRS ports in the consecutive downlink slots within the time period.

In some example embodiments, the first apparatus further comprises: means for receiving, from the second apparatus along with the indication, information of a plurality of sets of DMRS ports for scheduling the first apparatus and the at least one co-scheduled terminal device, wherein at least one set of DMRS ports from the plurality of sets of DMRS ports are kept constant within the time period, and wherein a DMRS port is allowed to be associated with more than one set from the plurality of sets of DMRS ports.

In some example embodiments, the first apparatus further comprises: means for receiving the indication and the information via at least one of the following: a radio resource control, RRC, message, a medium access control-control element, MAC-CE, or downlink control information, DCI.

In some example embodiments, the first apparatus further comprises: means for receiving, in a first downlink slot in the consecutive downlink slots within the time period, first information, indicating a first pre-determined number of DMRS ports from the set of DMRS ports; means for storing the first pre-determined number of DMRS ports; and means for performing a first blind detection on a second pre-determined number of DMRS ports randomly selected from the set of DMRS ports.

In some example embodiments, the first apparatus further comprises: means for in accordance with a determination that a decoding of the first information based on a result of the first blind detection on the second pre-determined number of DMRS ports fails, storing in-phase/quadrature, I/Q, data associated with the first downlink slot; or means for in accordance with a determination that the decoding is successful, storing detected DMRS ports from the second pre-determined number of DMRS ports.

In some example embodiments, the first apparatus further comprises: means for receiving, in a second downlink slot in the consecutive downlink slots within the time period, second information indicating a third pre-determined number of DMRS ports from the set of DMRS ports; means for performing a second blind detection on the first pre-determined number of DMRS ports and a fourth pre-determined number of DMRS ports, wherein the fourth number equals to the second number minus the size of first pre-determined number of ports; and means for decoding the second information associated with the second downlink slot based on a result of the second blind detection.

In some example embodiments, the first apparatus further comprises: means for performing a third blind detection on the stored I/Q data associated with the first downlink slot based on the third pre-determined number of DMRS ports and the fourth pre-determined number of DMRS ports; and means for decoding the first information associated with the first downlink slot based on a result of the third blind detection.

In some example embodiments, the first apparatus further comprises: means for receiving, in a first downlink slot in the consecutive downlink slots within the time period, first information, indicating a first pre-determined number of DMRS ports from the set of DMRS ports; means for storing the first pre-determined number of DMRS ports; and means for performing a first blind detection on a second pre-determined number of DMRS ports randomly selected from DMRS ports other than the first pre-determined number of DMRS ports in at least one set of DMRS ports associated with the first pre-determined number of DMRS ports from the plurality of sets of DMRS ports.

In some example embodiments, the first apparatus further comprises: means for in accordance with a determination that a decoding of the first information based on a result of the first blind detection on the second pre-determined number of DMRS ports fails, storing in-phase/quadrature, I/Q, data associated with the first downlink slot; or means for in accordance with a determination that the decoding is successful, storing detected DMRS ports from the second pre-determined number of DMRS ports.

In some example embodiments, the first apparatus further comprises: means for receiving, in a second downlink slot in the consecutive downlink slots within the time period, second information indicating a third pre-determined number of DMRS ports from a first set of DMRS ports in at least one set of DMRS ports associated with the first pre-determined number of DMRS ports; means for performing a second blind detection on a fourth pre-determined number of DMRS ports selected from at least one of the set from the plurality of sets of DMRS ports which contains both first and third pre-determined DMRS ports; and means for decoding the second information associated with the second downlink slot based on a result of the second blind detection.

In some example embodiments, the first apparatus further comprises: means for performing a third blind detection on the stored I/Q data associated with the first downlink slot based on the fourth pre-determined number of DMRS ports selected from at least one of the set from the plurality of sets of DMRS ports which contains both first and third pre-determined DMRS ports; and means for decoding the first information associated with the first downlink slot based on a result of the third blind detection.

In some example embodiments, the first apparatus comprises a terminal device and the second apparatus comprises a network device.

In some example embodiments, the first apparatus further comprises means for performing other operations in some example embodiments of the method 500 or the first apparatus 210. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 220 in FIG. 2) may comprise means for performing the respective operations of the method 600. The means may be implemented in any suitable form. For example, the means may be implemented in a circuitry or software module. The second apparatus may be implemented as or included in the second apparatus 220 in FIG. 2.

In some example embodiments, the second apparatus comprises means for transmitting, to a first apparatus, an indication of a time period within which at least one co-scheduled terminal device of the first apparatus is present and a set of demodulation reference signal, DMRS, ports allocated for the first apparatus and the at least one co-scheduled terminal device are constant.

In some example embodiments, the first apparatus and the at least one co-scheduled terminal device are co-scheduled over same and/or overlapping time and frequency resources.

In some example embodiments, the second apparatus further comprises: means for transmitting the indication via at least one of the following: a radio resource control, RRC, message, a medium access control-control element, MAC-CE, or downlink control information, DCI.

In some example embodiments, the second apparatus further comprises: means for transmitting, to the first apparatus, information of different DMRS ports of the set of DMRS ports in consecutive downlink slots within the time period.

In some example embodiments, the second apparatus further comprises: means for transmitting, to a first apparatus along with the indication, information of a plurality of sets of DMRS ports for scheduling the first apparatus and at least one co-scheduled terminal device of the first apparatus, wherein at least one set of DMRS ports from the plurality of sets of DMRS ports is kept constant within the time period, and wherein a DMRS port is allowed to be associated with more than one set from the plurality of sets of DMRS ports.

In some example embodiments, the second apparatus further comprises: means for transmitting the indication and the information via at least one of the following: a radio resource control, RRC, message, a medium access control-control element, MAC-CE, or downlink control information, DCI.

In some example embodiments, the first apparatus comprises a terminal device and the second apparatus comprises a network device.

In some example embodiments, the second apparatus further comprises means for performing other operations in some example embodiments of the method 600 or the second apparatus 220. In some example embodiments, the means comprises at least one processor; and at least one memory storing instructions that, when executed by the at least one processor, cause the performance of the second apparatus.

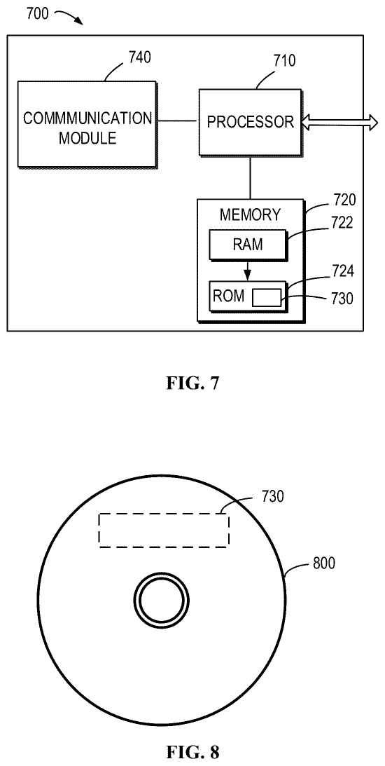

FIG. 7 is a simplified block diagram of a device 700 that is suitable for implementing example embodiments of the present disclosure. The device 700 may be provided to implement a communication device, for example, the first apparatus 210 or the second apparatus 220 as shown in FIG. 2, or the terminal device 110 or the network device 120 in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-22. (canceled)

23. A first apparatus comprising:
at least one processor; and
at least one memory storing instructions that, when executed by the at least one processor, cause the first apparatus at least to:
receive, from a second apparatus, an indication of a time period within which at least one co-scheduled terminal device of the first apparatus is present and a set of demodulation reference signal, DMRS, ports allocated for the first apparatus and the at least one co-scheduled terminal device are constant; and
decode one or more downlink data transmission in consecutive downlink slots within the time period at least based on the indication.

24. The first apparatus of claim 23, wherein the first apparatus and the at least one co-scheduled terminal device are co-scheduled over same and/or overlapping time and frequency resources.

25. The first apparatus of claim 23, wherein the first apparatus is caused to receive the indication via at least one of the following:
a radio resource control, RRC, message,
a medium access control-control element, MAC-CE, or
downlink control information, DCI.

26. The first apparatus of claim 23, wherein the first apparatus is caused to:
receive, from the second apparatus, information of different DMRS ports of the set of DMRS ports in the consecutive downlink slots within the time period.

27. The first apparatus of claim 23, wherein the first apparatus is caused to:
receive, from the second apparatus along with the indication, information of a plurality of sets of DMRS ports for scheduling the first apparatus and the at least one co-scheduled terminal device, wherein at least one set of DMRS ports from the plurality of sets of DMRS ports are kept constant within the time period, and wherein a DMRS port is allowed to be associated with more than one set from the plurality of sets of DMRS ports.

28. The first apparatus of claim 27, wherein the first apparatus is caused to receive the indication and the information via at least one of the following:
a radio resource control, RRC, message,
a medium access control-control element, MAC-CE, or
downlink control information, DCI.

29. The first apparatus of claim 23, wherein the first apparatus is caused to:
receive, in a first downlink slot in the consecutive downlink slots within the time period, first information, indicating a first pre-determined number of DMRS ports from the set of DMRS ports;
store the first pre-determined number of DMRS ports; and
perform a first blind detection on a second pre-determined number of DMRS ports randomly selected from the set of DMRS ports.

30. The first apparatus of claim 29, wherein the first apparatus is caused to:
in accordance with a determination that a decoding of the first information based on a result of the first blind detection on the second pre-determined number of DMRS ports fails, store in-phase/quadrature, I/Q, data associated with the first downlink slot; or
in accordance with a determination that the decoding is successful, store detected DMRS ports from the second pre-determined number of DMRS ports.

31. The first apparatus of claim 30, wherein the first apparatus is caused to:
receive, in a second downlink slot in the consecutive downlink slots within the time period, second information indicating a third pre-determined number of DMRS ports from the set of DMRS ports;
perform a second blind detection on the first pre-determined number of DMRS ports and a fourth pre-determined number of DMRS ports, wherein the fourth number equals to the second number minus the size of first pre-determined number of ports; and
decode the second information associated with the second downlink slot based on a result of the second blind detection.

32. The first apparatus of claim 31, wherein the first apparatus is caused to:
perform a third blind detection on the stored I/Q data associated with the first downlink slot based on the third pre-determined number of DMRS ports and the fourth pre-determined number of DMRS ports; and
decode the first information associated with the first downlink slot based on a result of the third blind detection.

33. The first apparatus of claim 27, wherein the first apparatus is caused to:
receive, in a first downlink slot in the consecutive downlink slots within the time period, first information, indicating a first pre-determined number of DMRS ports from the set of DMRS ports;
store the first pre-determined number of DMRS ports; and
perform a first blind detection on a second pre-determined number of DMRS ports randomly selected from DMRS ports other than the first pre-determined number of DMRS ports in at least one set of DMRS ports associated with the first pre-determined number of DMRS ports from the plurality of sets of DMRS ports.

34. The first apparatus of claim 33, wherein the first apparatus is caused to:
in accordance with a determination that a decoding of the first information based on a result of the first blind detection on the second pre-determined number of DMRS ports fails, store in-phase/quadrature, I/Q, data associated with the first downlink slot; or
in accordance with a determination that the decoding is successful, store detected DMRS ports from the second pre-determined number of DMRS ports.

35. The first apparatus of claim 34, wherein the first apparatus is caused to:
receive, in a second downlink slot in the consecutive downlink slots within the time period, second information indicating a third pre-determined number of DMRS ports from a first set of DMRS ports in at least one set of DMRS ports associated with the first pre-determined number of DMRS ports;
perform a second blind detection on a fourth pre-determined number of DMRS ports selected from at least one of the set from the plurality of sets of DMRS ports which contains both first and third pre-determined DMRS ports; and
decode the second information associated with the second downlink slot based on a result of the second blind detection.

36. The first apparatus of claim 35, wherein the first apparatus is caused to:
perform a third blind detection on the stored I/Q data associated with the first downlink slot based on the fourth pre-determined number of DMRS ports selected from at least one of the set from the plurality of sets of DMRS ports which contains both first and third pre-determined DMRS ports; and
decode the first information associated with the first downlink slot based on a result of the third blind detection.

37. A second apparatus comprising:
at least one processor; and
at least one memory storing instructions that, when executed by the at least one processor, cause the second apparatus at least to:
transmit, to a first apparatus, an indication of a time period within which at least one co-scheduled terminal device of the first apparatus is present and a set of demodulation reference signal, DMRS, ports allocated for the first apparatus and the at least one co-scheduled terminal device are constant.

38. The second apparatus of claim 37, wherein the first apparatus and the at least one co-scheduled terminal device are co-scheduled over same and/or overlapping time and frequency resources.

39. The second apparatus of claim 37, wherein the second apparatus is caused to:
transmit the indication via at least one of the following:
a radio resource control, RRC, message,
a medium access control-control element, MAC-CE, or
downlink control information, DCI.

40. The second apparatus of claim 37, wherein the second apparatus is caused to:
transmit, to the first apparatus, information of different DMRS ports of the set of DMRS ports in consecutive downlink slots within the time period.

41. The second apparatus of claim 37, wherein the second apparatus is caused to:
transmit, to a first apparatus along with the indication, information of a plurality of sets of DMRS ports for scheduling the first apparatus and at least one co-scheduled terminal device of the first apparatus, wherein at least one set of DMRS ports from the plurality of sets of DMRS ports is kept constant within the time period, and wherein a DMRS port is allowed to be associated with more than one set from the plurality of sets of DMRS ports.

42. The second apparatus of claim 41, wherein the second apparatus is caused to transmit the indication and the information via at least one of the following:
a radio resource control, RRC, message,
a medium access control-control element, MAC-CE, or
downlink control information, DCI.
